(19) United States
(12) Patent Application Publication
(10) Pub. No.: US 2026/0105865 A1
(43) Pub. Date: Apr. 16, 2026

(54) Complex Anatomy Recognition and Simulation Foley Catheter Trainer

(71) Applicant: The Government of the United States, as Represented by the Director of the Defense Health Agency, Fort Detrick, MD (US)

(72) Inventors: Carolyn Anne Salter, Dupont, WA (US); Timothy William Wright, Tacoma, WA (US); Jonathan Thomas Wingate, Seattle, WA (US)

(21) Appl. No.: 19/356,604

(22) Filed: Oct. 13, 2025

Related U.S. Application Data
(60) Provisional application No. 63/706,335, filed on Oct. 11, 2024.

(51) Int. Cl. G09B 23/30; G09B 23/34

(52) U.S. Cl. CPC G09B 23/303; G09B 23/34

(57) ABSTRACT

A modular catheter trainer includes a core housing, a core assembly, a genital assembly, and a fluid reservoir. The core housing has a base wall, a first side wall that extends from the base wall, a second side wall that extends from the base wall, and a cavity. The core assembly removably positionable within the cavity and includes a body having a first face and a second face and a passageway extending through the body between the first face and the second face. The shape of a passageway is configured to model a shape of a human urethra. The genital assembly is coupled to the first face in fluid communication with the passageway. The genital assembly has a shape of external human genitalia. The fluid reservoir assembly is coupled to the core housing proximate to the second face and in fluid communication with the passageway.

### CROSS-REFERENCE TO RELATED APPLICATION

This application claims the benefit of U.S. Provisional Application No. 63/706,335, filed Oct. 11, 2024, the contents of which is incorporated herein by reference in its entirety.

### GOVERNMENT INTEREST

The disclosure described herein may be manufactured, used, and licensed by or for the U.S. Government.

### FIELD

The present disclosure relates to a catheter trainer. More particularly, the present disclosure relates to a catheter trainer for patients with abnormal anatomy.

### BACKGROUND

A foley catheter is a medical device that is inserted into a patient's urethra and drains urine from the patient's bladder. Once in place, the catheter may remain in the patient's urethra for a period of time.

A clinician and/or patient may use a trainer or model to practice inserting a catheter into a simulated urethra. The trainer or model may be designed to simulate the anatomy of a male or female patient. This may assist in making the insertion on the actual patient easier.

Generally, these trainers are designed to simulate the normal anatomy in a human patient. However, the physical characteristics of many patients do not reflect the normal anatomy. The abnormal physical characteristics may affect how the catheter is inserted into a patient's body. Using a trainer that has the normal anatomy may be ineffective at providing the necessary practice of inserting the catheter because the physical characteristics vary between the trainer and the patient. A need exists for a catheter trainer that includes one or more physical abnormalities so that clinicians and/or patients can gain experience inserting a catheter on patients that they are likely to see.

### SUMMARY

Various embodiments of the present disclosure can overcome various of the aforementioned and other disadvantages associated with known catheter training modules and offer new advantages as well.

According to one aspect of various embodiments of the present disclosure there is provided a modular catheter trainer that includes a base module, a male core module and a female core module. The base module includes an opening and a first base connector disposed radially outside of the opening. The male core module includes a shaft with a first end and a second end, a channel that extends between the first end and the second end, and a first external connector disposed proximate to the first end. The male core module can represent male genitalia having a first anatomical abnormality. The shaft includes a shaft opening configured to receive a catheter. The female core module includes a body having an outer perimeter, a second external connector disposed proximate to the outer perimeter, and an opening extending through the body. The female core module can represent female genitalia with a second anatomical abnormality. The opening can receive the catheter. The first base connector can removably connect to the first external connector or the second external connector. A selected one of the male core module and the female core module can be in fluid communication with the opening.

In some forms, a modular catheter trainer includes a core housing, a core assembly, a genital assembly, and a fluid reservoir. The core housing has a base wall, a first side wall that extends from the base wall, a second side wall that extends from the base wall, and a cavity at least partially formed between the first side wall and the second side wall. The core assembly removably positionable within the cavity and includes a body having a first face and a second face and a passageway extending through the body between the first face and the second face. The shape of a passageway is configured to model a shape of a human urethra. The genital assembly is coupled to the first face in fluid communication with the passageway. The genital assembly has a shape of external human genitalia. The fluid reservoir assembly is coupled to the core housing proximate to the second face and in fluid communication with the passageway.

According to another aspect of various embodiments of the present disclosure, there is provided a method of using a catheter trainer. The method includes selecting an external module between a male module and a female module. The male module can represent a male genital structure with a first abnormality. The female module can represent a female genital structure with a second abnormality. The method further includes coupling the selected external module to a base module. The method further includes fluidly coupling a tube in the selected external module to an opening in the base module. The tube can replicate a urethra and can receive a catheter.

In some forms, there is a method of using a catheter trainer. A practice core assembly is selected from a first core assembly and a second core assembly. The practice core assembly is inserted into a cavity of a core housing. A reservoir assembly is connected to the core housing in fluid communication with the practice core assembly. The fluid reservoir assembly includes a reservoir volume and a one-way valve. A male genital assembly or a female genital assembly based on a shape of the practice core assembly. A selected one of the male genital assembly and the female genital assembly is connected to the practice core assembly. A catheter tube is inserted through the selected one of the male genital assembly and the female genital assembly, a passageway of the practice core assembly, and the one-way valve. The catheter tube can permit liquid to drain from reservoir volume.

In some forms, there is a method of using a catheter trainer. A practice core assembly is selected from a first core assembly and a second core assembly. The practice core assembly is inserted into a cavity of a core housing. A reservoir assembly is connected to the core housing in fluid communication with the practice core assembly. The fluid reservoir assembly includes a reservoir volume. A male genital assembly or a female genital assembly based on a shape of the practice core assembly. A selected one of the male genital assembly and the female genital assembly is connected to the practice core assembly. A torso section is removed from a manikin model by disconnecting the torso section from a pair of legs, and the core housing is connected to the pair of legs. A catheter tube is inserted through the selected one of the male genital assembly and the female genital assembly, a passageway of the practice core assembly, and the one-way valve. The catheter tube can permit liquid to drain from reservoir volume.

The disclosure herein should become evident to a person of ordinary skill in the art given the following enabling description and drawings. The drawings are for illustration purposes only and are not drawn to scale unless otherwise indicated. The drawings are not intended to limit the scope of the invention. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred embodiments and reference to the accompany drawing wherein:

FIG. 1 is a schematic view of a base module of a catheter trainer according to one example.

FIG. 2 is a schematic view of an alternate example of a base module of a catheter trainer.

FIG. 3 is a schematic view of a male core module usable with the base module of FIG. 1.

FIG. 4 is a schematic view of the male core module of FIG. 3 coupled to the base module of FIG. 1.

FIG. 5 is a schematic view of a male core module and a foreskin module coupled to the base module of FIG. 1.

FIG. 6 is a schematic view of an obesity module coupled to the base module of FIG. 1 to simulate a buried penial condition.

FIG. 7 is a cross-sectional view of the obesity module of FIG. 6.

FIGS. 8A-8E are schematic views of different examples of a core removably insertable into the male core module of FIG. 1.

FIG. 9 is a schematic view of a female core module usable with the base module of FIG. 1.

FIG. 10 is a cross-sectional view of the female core module of FIG. 9 with a core representing a first anatomical shape of a urethra.

FIG. 11 is a cross-sectional view of an alternate example of the female core module of FIG. 9 with a core representing a second anatomical shape of a urethra.

FIG. 12 is a schematic view of an obesity module to simulate obesity in a female patient and usable with the base module of FIG. 1.

FIG. 13 is a detail view of the obesity module of FIG. 12.

FIG. 14 is a perspective view according to another example of a catheter trainer with a male genital model.

FIG. 14-1 is a perspective view according to another example of a catheter trainer with a female genital model.

FIG. 15 is an exploded view of the catheter trainer of FIG. 14.

FIG. 15-1 is an exploded view of the catheter trainer of FIG. 14-1.

FIG. 16 is a perspective view of a first base module usable with the catheter trainer of FIG. 14.

FIG. 17 is a cross-sectional view of the first base model of FIG. 16.

FIG. 18 is a perspective view of a second base module usable with the catheter trainer of FIG. 14.

FIG. 19 is a cross-sectional view of the second base module.

FIG. 20 is a rear perspective view of a male genital module usable with the first base module of FIG. 16.

FIG. 20-1 is a rear perspective view of a female genital module usable with the first base module of FIG. 18.

FIG. 21 is a perspective view of a fluid reservoir of the catheter trainer of FIG. 14.

FIG. 22 is a perspective view of a valve of the fluid reservoir of FIG. 21.

FIG. 23 is a perspective view of the catheter trainer of FIG. 14 coupled to a manikin.

### DETAILED DESCRIPTION

FIG. 1 shows a base module 100 of a catheter trainer 50. In the illustrated example, the base module 100 may be a gender-neutral module. As described in more detail below, the base module 100 can be modified by a clinician to replicate the anatomy of either a male or female patient.

In some forms, the base module 100 may include a truncated section of a human body. For example, the base module 100 may include a torso segment 105 and a pair of legs 110 that extend from the torso segment 105. In the illustrated example, the torso segment 105 may not depict a full-sized human torso. Instead, the torso segment 105 may include only the lower torso region. However, other examples of the base module 100 may include a larger section of a torso (e.g., the entire torso).

Similarly, each leg 110 depicted in the base module 100 may include only a portion of the leg 110. For example, the illustrated leg 110 on the base module 100 may not extend below a knee. However, other examples may include a leg 110 with any length, or the leg 110 may be omitted.

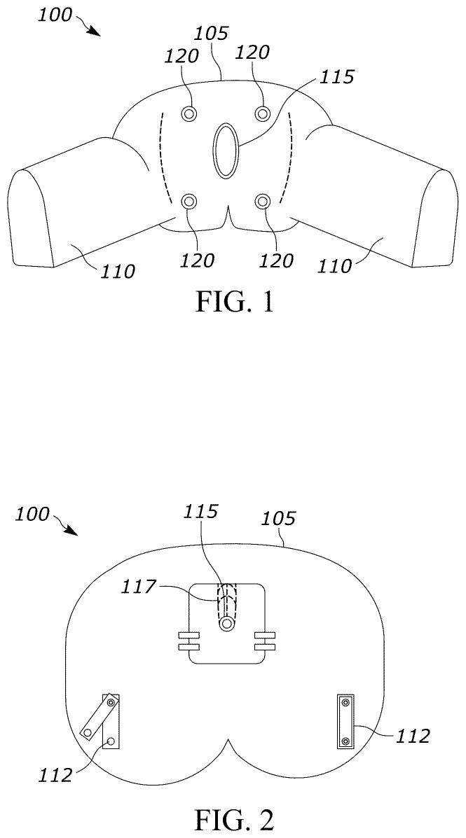

In one form, the legs 110 may be removably coupled to the torso segment 105. For example, FIG. 2 illustrates an alternate example of the base module 100 where legs 110 are not connected to the torso segment 105. The base module 100 may include a locking mechanism 112 for removably coupling legs 110 to the torso segment 105. The illustrated locking mechanism 112 is a mechanical lock, although other locking mechanisms (e.g., magnetic, adhesive, hook and loop material, ball and socket, etc.) may be used.

In some forms, the base module 100 may include an opening 115, which may be disposed between the pair of legs 110. As described in more detail below, the opening 115 may be an opening to a tube or conduit 117 in fluid communication with a reservoir (representing a patient's bladder). The opening 115 may be an elongated opening or the opening 115 may include a substantially constant width.

In certain forms, one or more connectors 120 (e.g., four shown) may be disposed on the base module 100. For example, the connectors 120 may be disposed around the opening 115 and radially inside of the legs 110. The connectors 120 may be mechanical connectors, magnetic connectors, adhesive connectors, hook and loop material, and/or any other similar connector type. As described in more detail below, the connectors 120 may be used to couple an additionally module to the base module 100.

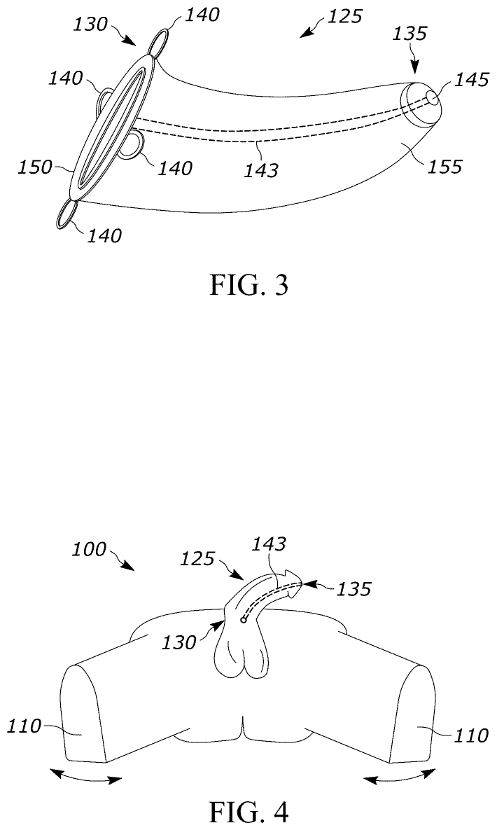

As shown in FIGS. 3 and 4, a first module 125 may be represent male anatomical features. For example, the first module 125 may represent a penis and include a first end 130 and a second end 135 opposite the first end.

The first end 130 may be configured to removably connect to the base module 100. In particular, the first end 130 may connect to the base module 100 proximate to the opening 115 to transform the anatomically neutral base module 100 into a male module.

As shown in FIG. 3, the first end 130 may include one or more connectors 140 that are complementary to the connectors 120 on the base module 100. For example, the connectors 140 may be complementary mechanical connectors, magnetic connectors, adhesive connectors, hook and loop material, and/or any other similar connector type to engage with the connectors 120. In other examples (not shown), the male module 125 may be integrally formed with the base module 100.

The male module 125 may include a channel or passageway 132 between the first end 130 and the second end 135. The passageway 143 may represent a urethra and may be shown in hidden lines. The passageway 143 may be open at both the first end 130 and the second end 135. When the male module 125 is connected to the base module 100, a passageway opening 145 may be positioned proximate to the opening 115 on the base module 100, thereby providing fluid communication between the base module 100 and the male module 125. In some forms, a gasket 150 may be disposed around the passageway opening 145. The gasket 150 may contact the base module 100 radially outside of the opening 115 to provide a substantially sealed interface between the base module 100 and the male module 125.

The second end 135 of the male module 125 may include a urethral opening. As described in more detail below, a clinician may insert a catheter into the opening at the second end 135 to practice using a catheter on a living patient.

In some forms, the male module 125 may include an outer layer 155, which replicates the foreskin of a penis. Certain patients may experience phimosis, which is the inability to retract the foreskin from the head of the penis. A patient with this condition may have their urethral opening at least partially blocked by the foreskin, which can make insertion of a catheter difficult.

With continued reference to FIG. 3, the male module 125 may include the outer layer 155 that at least partially covers the second end 135 to simulate a patient with phimosis. The opening at the second end 135 is therefore at least partially obstructed by the outer layer 155. A clinician may practice inserting a catheter on a patient with phimosis using the male module 125.

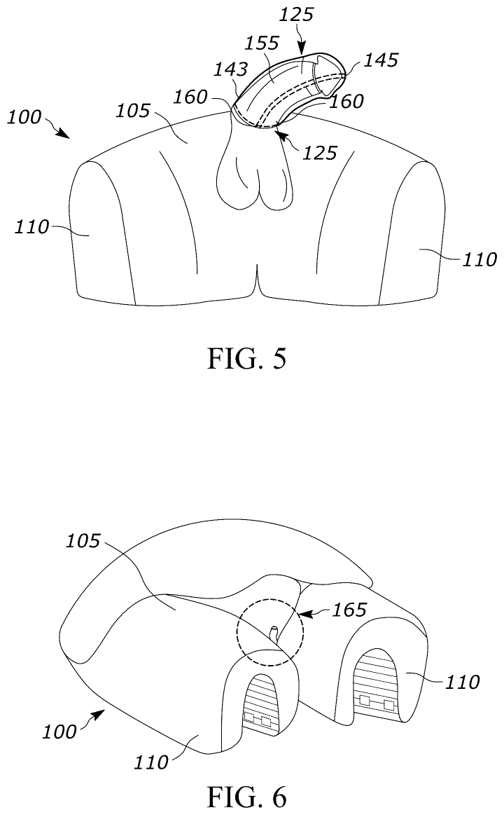

As shown in FIG. 5, other examples may include the outer layer 155 may be formed as a sleeve that may be removably coupled to the male module 125. For example, the male module 125 may replicate a healthy penis (or penis with any other abnormality). A clinician may removably couple the outer layer 155 over the male module 125 by using separate connectors 160 on the outer layer 155. The outer layer connectors may connect to the male module 125 and/or the base module 100. Once connected, the combination may be similar to the one-piece example illustrated in FIG. 3 and may permit the clinician to practice inserting a catheter into a patient with phimosis.

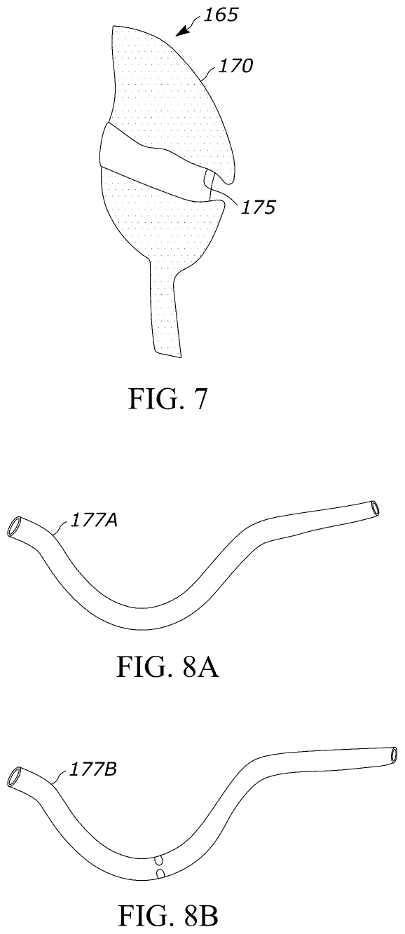

Obesity in a patient may also negatively affect a clinician ability to insert a catheter. Particularly, obesity in males may cause the penis to be buried, and less accessible for insertion of the catheter. As shown in FIGS. 6 and 7, a fourth or obesity module 165 may be coupled to the base module 100 to simulate an obese male patient. For example, the fourth module 165 replicate a buried penis retracting into a fat pad.

As shown in FIG. 7, the obesity module 165 may include a body 170 and an aperture 175 that extends through the body 170 (e.g., entirely through the body 170). The aperture 175 may have a width that is substantially similar to the width of the male module 125.

In some forms, the obesity module 165 may be positioned with the aperture 175 proximate to the to the second end 135 of the male module 125. When the two are aligned, the obesity module 165 may be slid onto the male module 125. A clinician may slide the obesity module 165 so that it contacts the base module 100 and so that the male module 125 is fully received within the aperture 175. The obesity module 165 may have connectors that engage the male module 125 and/or the base module 100 to secure the obesity module 165 in place. The connectors may be mechanical connectors, magnetic connectors, adhesive connectors, hook and loop material, and/or any other similar connector type.

When connected, access to the second end 135 of the male module 125 may be at least partially obstructed by the body 170 of the obesity module 165. For example, the second end 135 may be positioned within the aperture 175. Use of this module 165 may assist a clinician in inserting a catheter into the urethra of an obese patient where the excess tissue of the patient buries or traps the patient's penis, making it more difficult to reach. The obesity module 165 replicates this because access to the second end 135 of the male module 125 is obstructed by the material of the obesity module 165 blocking or limiting the accessibility of the second end 135 within the body 170.

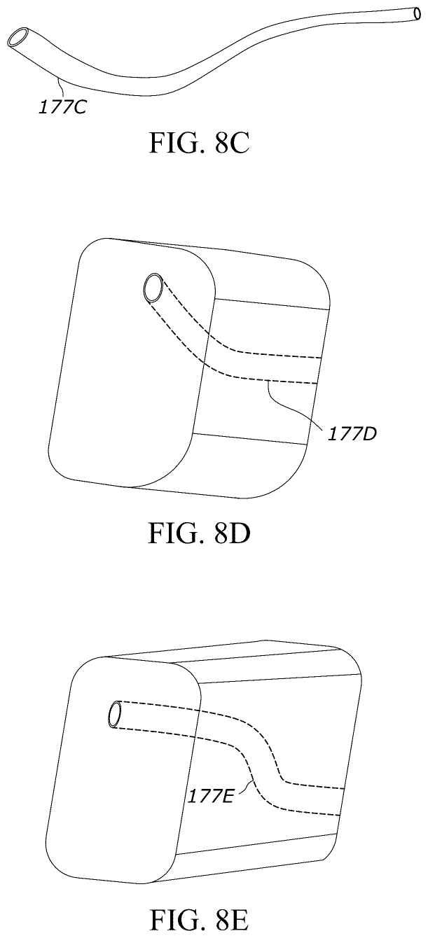

As shown in FIGS. 8A to 8C, a core 177 may be insertable into the base module 100 to simulate different structures of a urethra. Specifically, these cores 177 may simulate a urethral structure, which can involve the narrowing of the urethra. For example, FIG. 8A may illustrate a core 177A representing a generally healthy urethra. FIG. 8B may illustrate a core 177B representing a urethra with a bulbar structure. FIG. 8C may illustrate a core 177C representing a urethra with a fossa structure.

As shown in FIGS. 8D and 8E, alternate examples of a core 177 may be insertable into the base module 100 to simulate further abnormalities in a patient. For example, FIG. 8D may illustrate a side view of a normal core 177D, which may be similar to the core 177A, and represent the approximate shape of a urethra in a healthy individual. FIG. 8E may illustrate a core 177E representing the urethra of a patient with benign prostatic hypertrophy. For example, an enlarged or large prostate can expand into a space typically occupied by the urethra, forcing it to bend in an upward direction. A clinician can change between any of the above-described cores 177, or any similar core, to practice inserting a catheter on a patient with differently sized and/or shaped urethras.

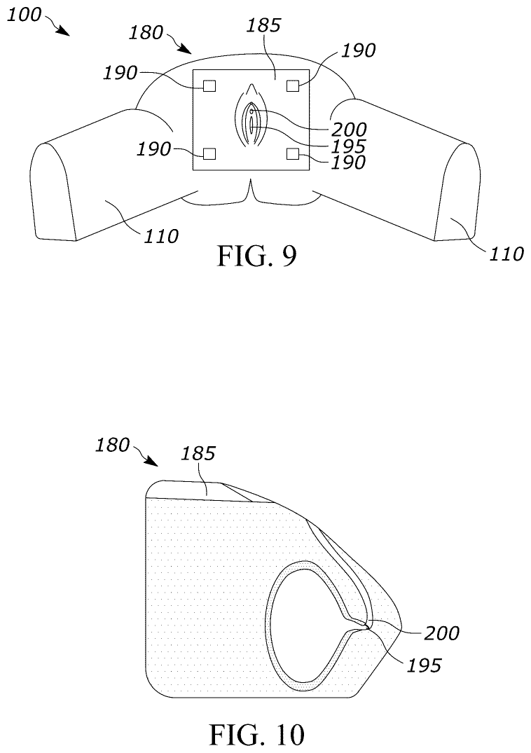

Because the base module 100 may be gender neutral, the clinician may alternatively couple a module to simulate the female anatomy and practice inserting a catheter into a female patient. As shown in FIG. 9, a fourth or female module 180 may replicate female anatomy and be used in catheter training.

In some forms, the female module 180 includes a body 185 and at least one connector 190 disposed proximate to an edge of the body 185. The one or more connectors 190 may be complementary to the connectors 120 of the base module 100 (e.g., mechanical fasteners, magnetic fasteners, adhesive, hook and loop material, etc.) and may permit the female module 180 to be removably coupled to the base module 100. In other examples, the female module 180 and the base module 100 may be integrally formed such that the base module represents female anatomy, and a separate base module could be used to represent male anatomy.

In certain forms, the body 185 may include a gasket or valve (not shown), which may contact a surface of the base module 100. Specifically, the gasket may be sized and shaped to extend radially outside of the opening 115 of the base module 100 when the female module 180 is coupled to the base module 100. As described in more detail below, the gasket can create a fluid seal to limit leakage of fluid through an interface between the base and female modules 100, 180.

As described above with respect to the male module 125, the female module 180 may be used to replicate abnormal anatomical conditions. For example, the female module 180 illustrated in FIG. 9 may replicate the atrophic vaginitis, which is a thinning and inflammation of the vaginal walls and may be present in post-menopausal women with lower levels of estrogen. Women who experience atrophic vaginitis may have thin and/or tight skin around the labia, resulting in a smaller vaginal opening. Additionally, the condition may cause the urethra to retract and angle away from the introitus. The urethra may therefore be difficult to reach for a clinician attempting to insert a catheter.

In some forms, the female module 180 of FIG. 9 may replicate a woman with atrophic vaginitis. Specifically, the body 185 may include a central opening 195 that may replicate a vaginal opening and may be aligned with the opening 115 of the base module 100 when the female module 180 is connected. The material around the central opening 195 may be thin and/or taut (e.g., as compared to the surrounding material of the body 185) to simulate the labia of a woman with atrophic vaginitis.

In some forms, a tube 200 may be positioned within the central opening 195 and in fluid communication with the opening 115 of the base module 100. The tube 200 may represent the urethra of the female patient. The positioning of the tube 200 within the central opening 195 (e.g., at least partially obstructed by the material surrounding the central opening 195) may assist in replicating a retracted urethra of a patient with atrophic vaginitis (see e.g., FIG. 10).

Because many women with atrophic vaginitis are older, these patients may experience decreased mobility, particularly in their hips and legs. For example, it may be uncomfortable for a patient to spread their legs to provide a clinician access to the urethra. The use of the female module of FIG. 9 may also be used with the legs 110 to simulate a patient who may struggle to move their legs about the hip.

In some forms, the legs 110 may be attached to the base module 100 in a fixed position, which may simulate the narrow hip angles of a patient. In this position, the legs 110 may obstruct or limit access to the central opening 195 and/or the tube 200. A clinician may therefore couple the legs 110 to the base module 100 with the female module 180 to practice working with a patient experiencing both conditions. In other forms, the legs 110 may be movable (e.g., pivotable) relative to the base module 100 so that the angle of the legs 110 may be adjusted. This may permit a clinician to practice working with patients with atrophic vaginitis with and without hip mobility limitations.

Women may also experience prolapse, which occurs when the muscles that support various organs weaken and cause the organs to drop from their natural position. Prolapsed organs can create bulges in the vagina which can distort urethral anatomy. Placing a catheter may be more difficult because the angle of entry into the urethra is different than in a healthy woman.

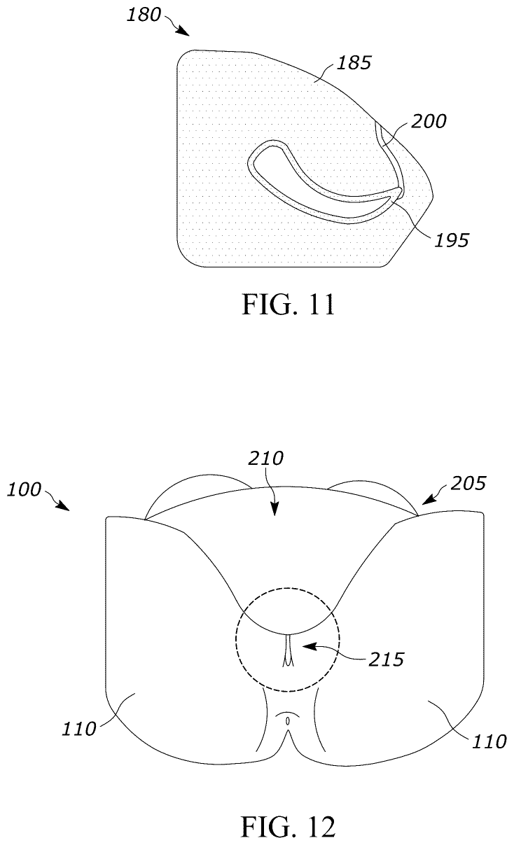

As shown in FIG. 11, the female module 180-1 may be modified to simulate a female patient with a pelvic organ prolapse. For example, female patients may experience one of several types of prolapse including cystocele prolapse, rectocele prolapse (e.g., when tissue of the patient's rectum pushes against the vaginal wall), and enterocele prolapse (e.g., when the patient's small intestine pushes against the vaginal wall). More specifically, the angle of the tube 200 may be more vertical (e.g., as viewed in FIG. 11) as compared to a healthy patient or to a patient with atrophic vaginitis (see e.g., FIG. 10). A female module 180-1 with a pelvic organ prolapse may be substituted for the female module 180 with the atrophic vaginitis. This female module 180-1 may replicate a general position of a patient's urethra who experiences any one of the three types of pelvic organ prolapse.

In other examples (not shown), a specific female module may be used to simulate a patient with each of the three variations of pelvic organ prolapse. For example, the internal elements of the module may specifically replicate the position of a patient's internal organs, instead of more generically modeling a generic position of the urethra.

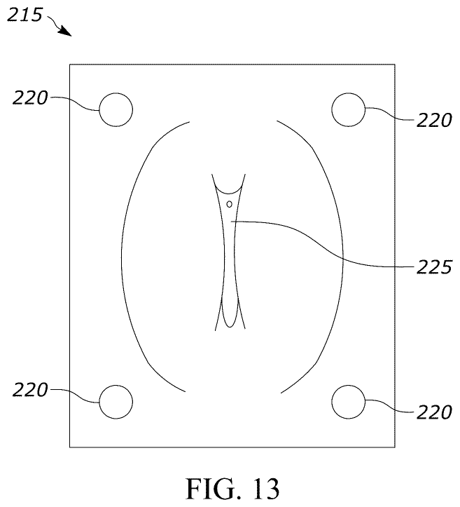

Women may also suffer from obesity, which may affect access to their urethra. As shown in FIGS. 12 and 13, a fifth or obesity module 205 may be coupled to the base module 100 to replicate a woman with obesity.

In some forms, the obesity module 205 may include a first portion 210 and a second portion 215. The first portion 210 may simulate a patient's stomach region and may overlay the torso segment 105 of the base module 100. The second portion 215 may simulate the genital region and may be similar to the female module 180 described above.

In certain forms, the first and second portions 210, 215 may be separable from one another and may be separably connectable to the base module 100. This may permit the clinician to use the first portion 210 with the female module 180 or the second portion 215. In certain forms, the first and second portions 210, 215 may be integrally formed with each other and may be connected together to the base module 100.

In some forms, the second portion 215 may include at least one connector 220. The one or more connectors 220 may be complementary to the connectors 120 of the base module 100 (e.g., mechanical fasteners, magnetic fasteners, adhesive, hook and loop material, etc.) and may permit the second portion 215 to be removably coupled to the base module 100. In other examples, the second portion 215 and the base module 100 may be integrally formed such that the base module represents female anatomy, and a separate base module could be used to represent male anatomy.

As shown in FIG. 13, the second portion 215 may include a central opening 225 with a tube (not shown), which may represent the vaginal opening and the urethra respectively. The material surrounding the central opening 225 may be larger (e.g., as compared to the female module 180) to replicate access tissue in the region on an obese patient who may have a larger and/or deeper labia. This additional material may at least partially cover the central opening 225 (e.g., the material may touch in the middle), thus obstructing a clinician's access to the urethra.

In use, the clinician may obtain a base module 100 and select a desired additional module to removably couple to the base module. The clinician can then use the resulting system to practice inserting a catheter. At any point, the clinician may replace the selected module for any other module and resume practicing inserting the catheter under the updated conditions. In this may, a clinician may practice assisting patients with both normal and abnormal anatomy.

In certain forms, the base module 100 may include a reservoir 119 that can replicate a patient's bladder. The reservoir 119 may be located at a rear of the base module 100 and may be removable and/or refillable with a fluid (e.g., water). In use, fluid communication may exist between the reservoir 119 and the replaceable module (e.g., water may be able to leave the reservoir 119 and exit the base module 100 through the opening of the removable module). This may assist the clinician by serving as a visual confirmation that the catheter was properly inserted. For example, a catheter inserted into the tube 200 and/or the second end 135 may convey fluid from the reservoir 119 (e.g., simulating a catheter conveying fluid from a patient's bladder). The presence of fluid flowing through the catheter may alert the clinician that the catheter was properly inserted into the module.

In one form, the base module 100 may assist clinicians in practicing using a suprapubic tube (not shown), which is a type of catheter that drains fluid directly from the bladder through an incision made in the patient's abdomen. The base module 100 may include a slit in the torso segment 105, which may provide fluid communication directly to the reservoir. For example, the base module 100 may include a tube or conduit that connects directly to the reservoir 119 through the torso segment 105. A clinician may insert a catheter through the slit and into the reservoir 119 to practice using a suprapubic tube. In some examples, the slit in the torso segment 105 may be selectively closeable (e.g., with a mechanical fastener, a magnet, an adhesive, etc.) depending on the use of the base module 100.

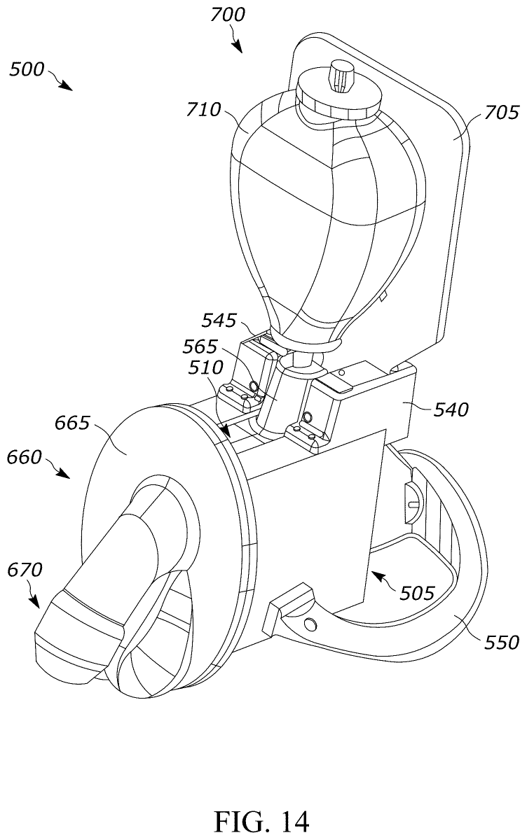

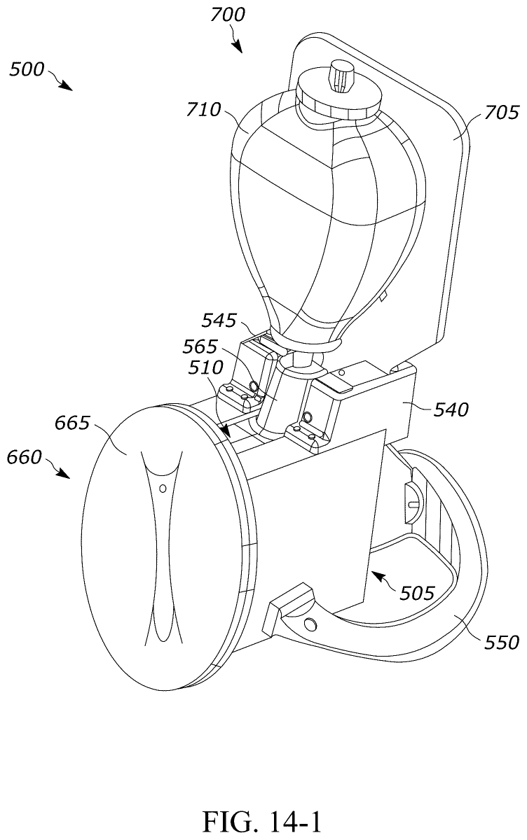

FIGS. 14 to 23 illustrate another example of a catheter trainer 500. The catheter trainer 500 may have some similarities to the catheter trainer 50. Only some similarities and differences between the catheter trainers 50, 500 may be described below.

As shown in FIGS. 14 to 15-1, the catheter trainer 500 may include a core housing 505 that can selectively receive a core assembly 510. The core housing 505 may be constructed from a rigid or semi-rigid material (e.g., metal, plastic, etc.). The illustrated the core housing 505 may have a substantially rectangular shape, although other examples of the core housing 505 may have different shapes.

In some forms, the core housing 505 may include a base wall 515 and a pair of side walls 520 that extend from the base wall 515 (e.g., parallel to the base wall 515). An interior cavity 525 may be formed between the base wall 515 and the pair of side walls 520. The core housing 505 may not include a front wall so that there is an unobstructed opening into the interior cavity 525.

In certain forms, an upper tab 530 may extend from each of the side walls 520. The upper tabs 530 may extend toward each other in a direction parallel to the base wall 505. The upper tabs 530 may be spaced apart so that a channel 535 is formed therebetween.

In some forms, a support 540 may be coupled to each of the tabs 530 and can extend away from the base wall 515. In the illustrated example, the supports 540 may include one or more grooves 545 that extend laterally across an upper surface of the support 540. A groove 545 on one support 540 may be aligned with a groove 545 on the other support 540 (e.g., along a common axis).

In one form, the support 540 may include a pair of grooves 545, with two grooves 545 laterally offset from one another. The grooves 545 may be parallel to one another and aligned with a respective groove 545 on the other support 540.

In some forms, a first connection feature 550 may be coupled to one or more of the side walls 520. For example, the first connection feature 550 may be a curved member that is connected between a side wall 540 and a rear of the core housing 505. However, other examples of the core housing 505 may have a different type of connection feature.

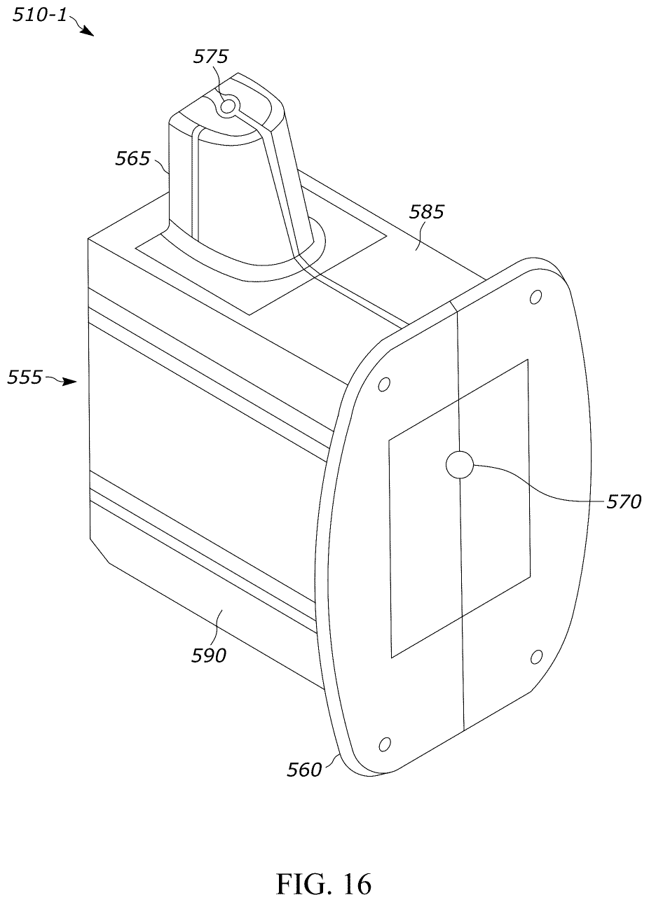

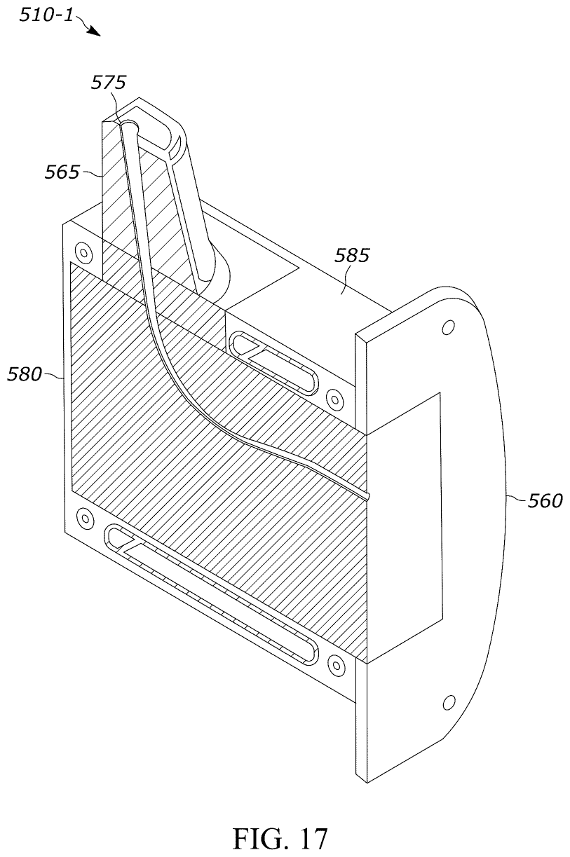

FIGS. 16 and 17 illustrate a first example of a core assembly 510-1, which may be used to replicate the urethra shape of a male patient. The core assembly 510-1 may include a body 555 that has a substantially similar shape as the interior cavity 525. As described in more detail below, this may permit the core assembly 510-1 to be removably inserted into the interior cavity 525.

In some forms, a front surface of the core assembly 510-1 may include a flange 560 that is wider than the body 555. The flange 560 may have maximum dimensions (e.g., length and/or width) that are greater than a distance between the side walls 520. As described in more detail below, this may limit the flange 560 from moving into the interior cavity 525.

In some forms, a projection 565 may extend from an upper surface of the body 555. In the illustrated example, the width of the projection 565 may be less than the width of the body 555. The projection 565 may include an opening 570 on an upper surface.

In certain forms, the front surface of the core assembly 510-1 may include an opening 575. The illustrated opening 575 may be disposed toward a superior end of front surface, although it may be disposed in a different location in other examples.

As shown in FIG. 17, a passageway 580 may be formed through the body 555 between the openings 570, 575. The passageway 580 may follow an at least partially curved path through the body 555 and can represent the shape of a human urethra. More specifically, the passageway 580 may replicate the shape of an anatomically correct human male urethra.

In certain forms, the body 555 may be formed from a first section 585 and a second section 590, which can be coupled together. As shown in FIG. 17, the first section 585 may include a series of holes 595 that can receive projections (not shown) from a second section 590 (see e.g., FIG. 16). The first and second sections 585, 590 may be coupled together (e.g., with a press fit, snap fit, friction fit, etc.) and selectively disconnected. This may permit a user to access the passageway 580 (e.g., to clean the interior of the body 555).

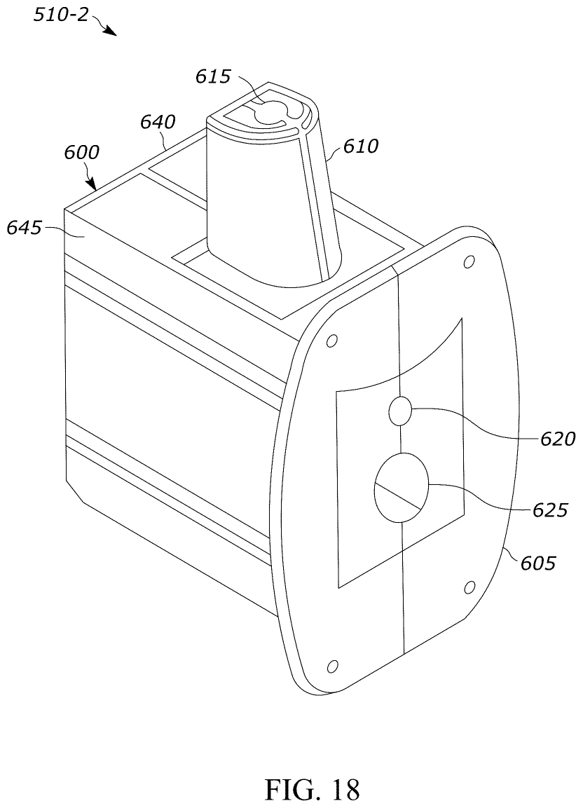

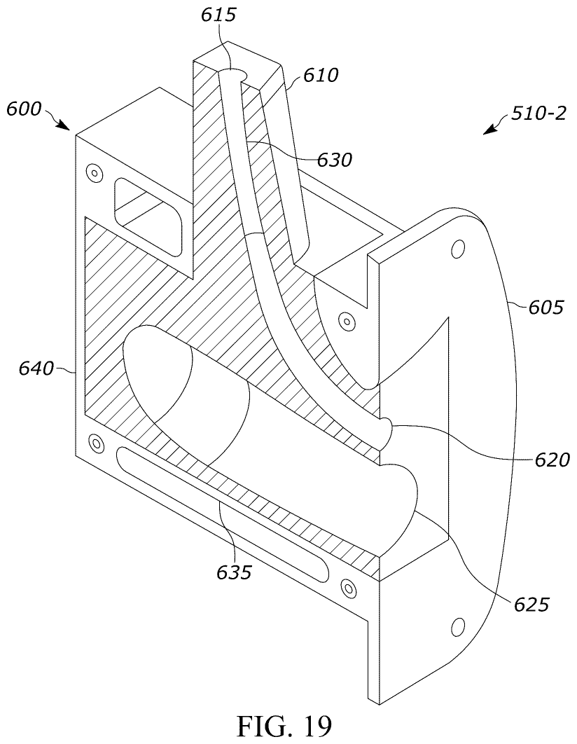

FIGS. 18 and 19 illustrate a second example of a core assembly 510-2, which may be used to replicate the urethra shape of a female patient. The core assembly 510-2 may include a body 600 that has a substantially similar shape as the interior cavity 525. The body 600 may also have a similar outer shape as the body 555 of the male core assembly 510-1. As described in more detail below, this may permit the core assembly 510-2 to be removably inserted into the interior cavity 525.

In some forms, a front surface of the core assembly 510-2 may include a flange 605 that is wider than the body 600. The flange 605 may have maximum dimensions (e.g., length and/or width) that are greater than a distance between the side walls 520. As described in more detail below, this may limit the flange 605 from moving into the interior cavity 525.

In some forms, a projection 610 may extend from an upper surface of the body 600. In the illustrated example, the width of the projection 610 may be less than the width of the body 600. The projection 610 may include an opening 615 on an upper surface.

In one form, the projection 610 may have a similar size and shape as the projection 565 of the male core assembly 510-1. However, the projection 610 may be disposed more proximate to the flange 605 than the projection 565 to its respective flange 560.

In certain forms, the front surface of the core assembly 510-2 may include an opening 620. The illustrated opening 620 may be disposed toward a superior end of front surface, although it may be disposed in a different location in other examples. The front surface may further include an aperture 625 spaced apart from the opening 620. In the illustrated example, the aperture 625 may be larger than the opening 620 and may be disposed more interior than the opening 620 (e.g., as seen in the orientation of FIG. 18).

As shown in FIG. 19, a passageway 630 may be formed through the body 600 between the openings 615, 620. The passageway 630 may follow an at least partially curved path through the body 600 and can represent the shape of a human urethra. More specifically, the passageway 600 may replicate the shape of an anatomically correct human female urethra.

In some forms, a second passageway 635 may be formed at least partially through the body 600 and may be spaced apart from the first passageway 630. The second passageway 635 may have a larger width than the first passageway 630.

In certain forms, the body 600 may be formed from a first section 640 and a second section 645, which can be coupled together. As shown in FIG. 19, the first section 640 may include a series of holes 650 that can receive projections (not shown) from a second section 645 (see e.g., FIG. 18). The first and second sections 640, 645 may be coupled together (e.g., with a press fit, snap fit, friction fit, etc.) and selectively disconnected. This may permit a user to access the passageway 630, 635 (e.g., to clean the interior of the body 600).

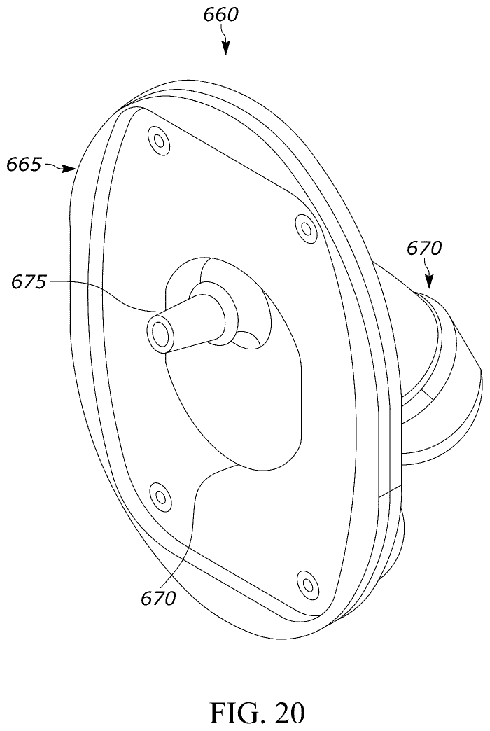

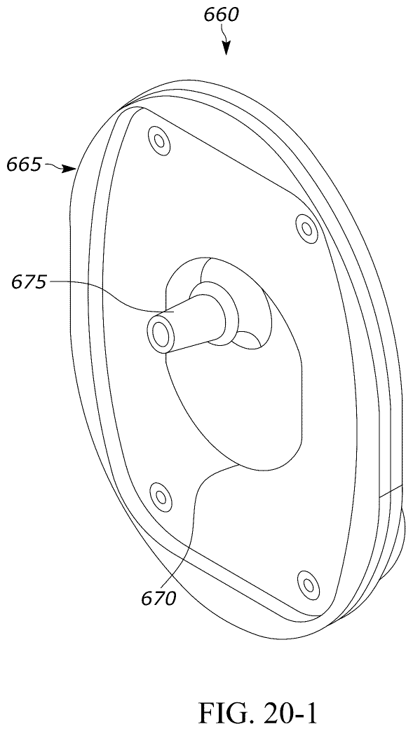

As shown in FIG. 20, an external or genital module 660 may include a frame 665 and a genital assembly 670 coupled to the frame 660. The illustrated genital assembly 670 may represent a male anatomy. FIG. 20-1 illustrates a similar genital assembly 670-1 that may represent a female anatomy.

In some forms, the frame 665 of both the male and female genital assemblies 670, 670-1 may include an opening 675, and a nozzle 680 may project from a rear of the genital assembly 670 through the opening 675. As described in more detail below, the nozzle 675 may be sized and shaped to fit through the opening 575 and within the passageway 580 (e.g., with a press fit). Alternatively, the nozzle 675 could fit through the opening 620 and into the passageway 630 when representing the female anatomy. Once connected, the genital assembly 670 may be fluidly connected to the passageway 580 (or passageway 630) via the nozzle 675.

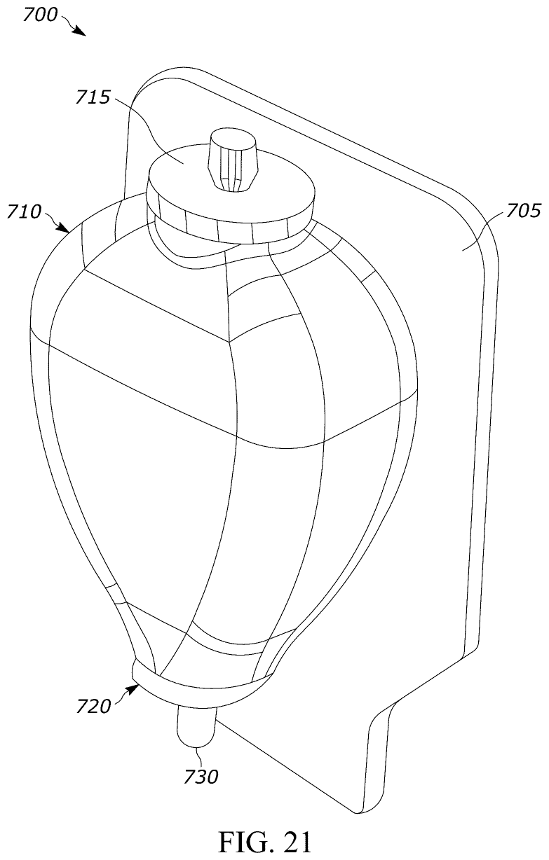

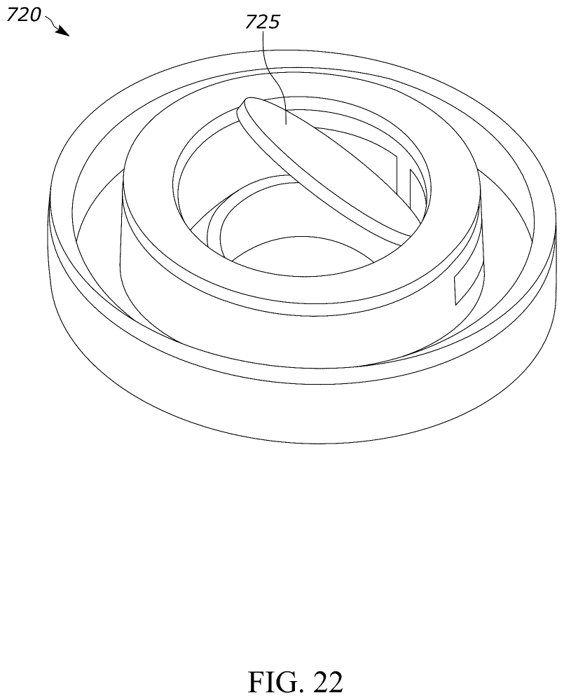

FIG. 21 illustrates a fluid reservoir assembly 700, which may include a support plate 705 and a reservoir volume 710 coupled to the support plate 705. In the illustrated example, the support plate 705 and the reservoir volume 710 may decrease in width toward one end (e.g., toward a lower end). As described in more detail below, the decrease in width may permit the fluid reservoir assembly to be received between the supports 540.

In some forms, an upper end of the reservoir volume 710 may include a cap 715 (e.g., a screw cap), which may be selectively coupled to the reservoir volume 710. The cap 715 may be removably coupled to the reservoir volume 710 to enclose the volume, and can be removed to allow for access to the volume (e.g., to refill the volume with additional liquid).

As shown in FIG. 22, a valve 720 may be used with the reservoir assembly 700 to limit fluid flow out of the reservoir volume 710. The valve 720 may be connected to a lower end of the reservoir volume 710 (e.g., opposite to the cap 715). The valve 720 may be a one-way valve and may include a flap 725 that is biased into a closed position (e.g., by a weight of the fluid within the reservoir volume 710).

Returning to FIG. 21, a nozzle 730 may be connected to the valve 720 so that the valve 720 is sandwiched between the nozzle 730 and the reservoir volume 710. The valve 720 therefore may limit fluid flow through the nozzle 730.

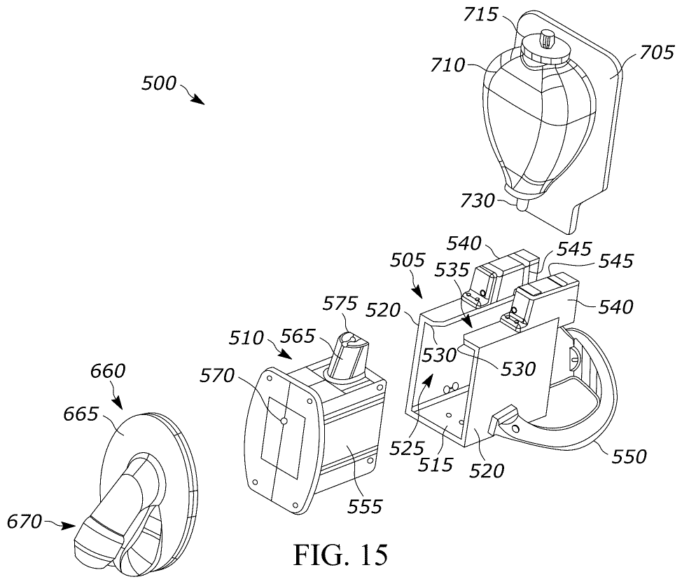

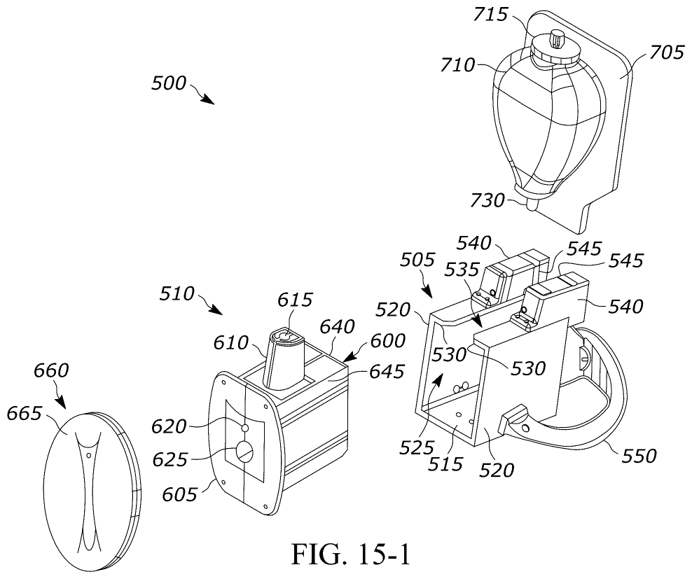

In use, the catheter trainer 500 may be assembled to permit a clinician to practice inserting a catheter on a variety of different patients (see e.g., FIG. 15). Specifically, the clinician may select a core assembly 510 and insert it into the core housing 505. The clinician may be selecting between the illustrated male core assembly 510-1 and the female core assembly 510-2. Additionally, there may be variations to the illustrated male and female core assemblies 510-1, 510-2 that the clinician can select from. For example, as illustrated above in FIGS. 8A to 8E, male patients may have different urethral structures. The clinician may therefore have additional examples of the male core assembly that includes a passageway 580 that has a different shape. Similarly, there may be multiple versions of the female core assembly 510-2 to represent different anatomical structures that a patient may have (e.g., atrophic vaginitis). In some forms, a clinician may have a separate core assembly for any of the above-described anatomical conditions that a male or female patient may have (or any similar condition not explicitly described).

The selected core assembly 510 may be inserted into the internal cavity 525 of the base assembly 505. For example, the core assembly 510 may be slid into the cavity 525. In some examples (not shown), one or more sides of the core assembly 510 may include rails to help guide the core assembly 510 into the cavity 525. In some examples, the core assembly 510 may engage with the core housing 505 once fully inserted. For example, the core housing 505 may include a fastener (e.g., a mechanical fastener, a magnet, hook and loop material, etc.) that can engage the core assembly 510 to keep it retained within the cavity 525.

In some forms, the projection 565, 610 may be positioned between the supports 540 when the respective core assembly 510 is fully inserted into the cavity 525. As described in more detail below, the projection 565 of the male core assembly 510-1 may be positioned more to the rear of the core housing 505 than the projection 610 of the female core assembly 510-2.

Once inserted, the respective genital module 660, 660-1 may be coupled to the selected core assembly 510 (e.g., a male genital module 660 selected for use with a male core assembly 510-1). More specifically, the nozzle 680 may be inserted into the opening 575 (e.g., in a fluid-tight engagement). In some forms, there may be additional connectors (e.g., mechanical fasteners, magnets, hook and loop material, etc.) that can be used to couple the genital module 660 to the selected core assembly 510.

The fluid reservoir assembly 700 may then be coupled to the core housing 505 by inserting the support plate 705 into one pair of grooves 545 in the supports 540. As described above, the projection 565, 610 may be disposed in a different position depending on whether the selected core assembly 510 represents the male anatomy or the female anatomy. The support plate 705 therefore may be inserted into the rearmost pair of grooves 545 when a male core assembly 510-1 is used and the frontmost pair or grooves 545 when the female core assembly 510-2 is used.

As the support plate 705 is inserted into the selected grooves, the nozzle 730 may be aligned with the opening 570, 620 on the respective core assembly 510. The nozzle 730 may be received within the respective opening 570, 620 with a fluid tight fit. A fluid pathway may then exist between the reservoir volume 710 and the nozzle 680 by way of the respective passageway 580, 630.

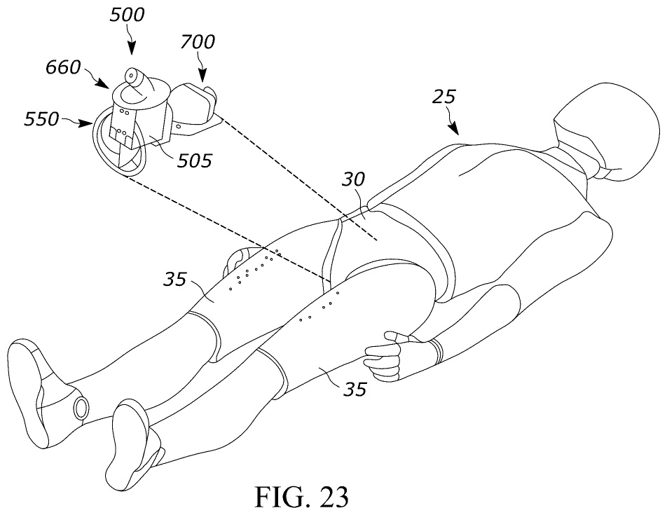

As shown in FIG. 23, the assembled catheter trainer 500 may be connected to a manikin or model 25. For example, a lower torso section 30 of the manikin 25 may be removed and can be replaced with the catheter trainer 500. In that example, a connection feature (not shown) of the manikin legs 35 may be coupled to the first connection features 550 of the catheter trainer 500. This may be accomplished through a ball and socket joint, a mechanical fastener, a magnet, hook and loop material, and/or an adhesive. Once connected, the body of the manikin 25 may simulate the challenges that a clinician may face when working with a real patient. For example, the manikin legs may impede access to the catheter trainer 500 similar to how a living person's legs may impede access (e.g., if the patient has hip mobility limitations). In other examples, the catheter trainer 500 may be used independently of the manikin 25.

The clinician may then use the catheter trainer 500 by inserting a catheter tube into the selected genital assembly 670 to access the respective passageway 580, 630 where it can continue to travel until it reaches the valve 720. When the reservoir volume 710 is filled with liquid (e.g., water), the flap 725 may be biased in the closed position to block the liquid from exiting the reservoir volume 710 and entering the respective passageway 580, 630. When the catheter tube contacts the flap 725, it may open slightly to permit some liquid to exit the reservoir volume 710 (but may prevent the entire volume of liquid from rushing out). The flap 725 may only open when the catheter tube is properly positioned. A clinician can use this to practice inserting a catheter into both male and female patients, with all variations of anatomy. After using one core assembly 510, the clinician may remove and replace it with another core assembly. In some forms, the body 555, 600 of the core assembly 510 may be separated after a use to permit the clinician to clean the passageway 580, 630 or any other interior part of the core assembly 510.

A clinician may also use any additional models (e.g., an obesity module, a foreskin module, etc.) with the selected core assembly 510 to simulate additional conditions that may appear in patients. These modules (e.g., as described above with respect to the first catheter trainer 50) may be separate from and removably connected to the core assembly 510 in a similar manner as described above. In other examples, the genital module 660 and the additional module may be formed together (e.g., a male genital assembly 670 formed with foreskin) so that the clinician has multiple genital modules 660 of the same gender to select from.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill will appreciate that the term clinician may generally refer to a doctor, nurse, medical student, or any other similar medical professional. Additionally, a person of ordinary skill will understand that non-medical professionals (e.g., patients, family or non-family caregivers, etc.) can similarly use the above-described trainer. Although not explicitly described, any action or function performed by a clinician may be similarly performed by a non-clinician.

One of ordinary skill in the art will also readily appreciate that it is well within the ability of the ordinarily skilled artisan to modify one or more of the constituent parts for carrying out the various embodiments of the disclosure. Once armed with the present specification, routine experimentation is all that is needed to determine adjustments and modifications that will carry out the present disclosure.

The above embodiments are for illustrative purposes and are not intended to limit the scope of the disclosure or the adaptation of the features described herein. Those skilled in the art will also appreciate that various adaptations and modifications of the above-described preferred embodiments can be configured without departing from the scope and spirit of the disclosure. Therefore, it is to be understood that, within the scope of the appended claims, the invention may be practiced other than as specifically described.

What is claimed is:

1-14. (canceled)

15. A modular catheter trainer comprising:
a core housing having a base wall, a first side wall that extends from the base wall, a second side wall that extends from the base wall, and a cavity at least partially formed between the first side wall and the second side wall;
a core assembly removably positionable within the cavity, wherein the core assembly includes,
a body having a first face and a second face, and
a passageway extending through the body between the first face and the second face, wherein the shape of a passageway is configured to model a shape of a human urethra;
a genital assembly coupled to the first face in fluid communication with the passageway, wherein the genital assembly has a shape of external human genitalia; and
a fluid reservoir assembly coupled to the core housing proximate to the second face and in fluid communication with the passageway.

16. The modular catheter trainer of claim 15, wherein the core assembly further includes a projection that extends from the second face, wherein the passageway extends through the projection, and wherein the fluid reservoir assembly is coupled to the projection.

17. The modular catheter trainer of claim 15, wherein the body includes a first section and a second section removably coupled to the first section.

18. The modular catheter trainer of claim 15, wherein,
the fluid reservoir assembly includes a reservoir volume and a support plate coupled to the reservoir volume; and
the core housing includes a support with a groove; and
the support plate is configured to be received within the groove.

19. The modular catheter trainer of claim 15, wherein the fluid reservoir includes,
a nozzle fluidly connected to the passageway; and
a valve configured to limit fluid flow.

20. The modular catheter trainer of claim 15, wherein the core housing includes a connection feature formed as a socket joint that is configured to engage with a manikin leg having a ball joint.

21. The modular catheter trainer of claim 15, wherein,
the core assembly is a male core assembly and the passageway is configured to model the shape of a male urethra; and
the genital assembly has the shape of male genitalia.

22. The modular catheter trainer of claim 15, wherein,
the core assembly is a female core assembly and the passageway is configured to model the shape of a female urethra; and
the genital assembly has the shape of female genitalia.

23. A method of using a catheter trainer, the method comprising:
selecting a practice core assembly between a first core assembly and a second core assembly,
inserting the practice core assembly into a cavity of a core housing; and
connecting a reservoir assembly to the core housing in fluid communication with the practice core assembly, wherein the fluid reservoir assembly includes a reservoir volume and a one-way valve;
selecting between a male genital assembly and a female genital assembly based on a shape of the practice core assembly;
connecting a selected one of the male genital assembly and the female genital assembly to the practice core assembly; and
inserting a catheter tube through the selected one of the male genital assembly and the female genital assembly, a passageway of the practice core assembly, and the one-way valve;
wherein the catheter tube is configured to permit liquid to drain from reservoir volume.

24. The method of claim 23, wherein the first core assembly is a male core assembly and the second core assembly is a female core assembly, wherein the male core assembly includes the passageway that is configured to correspond to a shape of a male urethra, and wherein the female core assembly includes the passageway that is configured to correspond to a shape of a female urethra.

25. The method of claim 23, wherein the first core assembly is a first male core assembly and the second core assembly is a second male core assembly, wherein the first male core assembly includes the passageway that is configured to correspond to a shape of a male urethra with a first abnormal condition, and wherein the second male core assembly includes the passageway that is configured to correspond to a shape of a male urethra with a second abnormal condition.

26. The method of claim 23, further comprising,
removing the practice core assembly from the cavity of the core housing;
inserting the other of the first core assembly and the second core assembly into the cavity;
selecting between the male genital assembly and the female genital assembly based on a shape of the other of the first core assembly and the second core assembly into the cavity; and
connecting a selected one of the male genital assembly and the female genital assembly to the other of the first core assembly and the second core assembly into the cavity.

27. The method of claim 23, wherein the reservoir assembly further includes a support plate coupled to the reservoir volume, the method further comprising inserting the support plate into a groove on the core housing and inserting a nozzle of the reservoir volume into an opening on the practice core assembly to fluidly connect the passageway to the reservoir volume.

28. The method of claim 23, further comprising,
removing a torso section from a manikin model by disconnecting the torso section from a pair of legs; and
connecting the core housing to the pair of legs.

29. The method of claim 23, wherein the male genital assembly and the female genital assembly each include a nozzle, the method further comprising inserting the nozzle from the selected one of the male genital assembly and the female genital assembly into an opening on the body to provide fluid connection to the passageway.

30. A method of using a catheter trainer, the method comprising:
selecting a practice core assembly between a first core assembly and a second core assembly,
inserting the practice core assembly into a cavity of a core housing; and
connecting a reservoir assembly to the core housing in fluid communication with the practice core assembly, wherein the fluid reservoir assembly includes a reservoir volume;
selecting between a male genital assembly and a female genital assembly based on a shape of the practice core assembly;
connecting a selected one of the male genital assembly and the female genital assembly to the practice core assembly;
removing a torso section from a manikin model by disconnecting the torso section from a pair of legs;
connecting the core housing to the pair of legs; and
inserting a catheter tube through the selected one of the male genital assembly and the female genital assembly and a passageway of the practice core assembly, wherein the passageway is shaped like a urethra;
wherein the catheter tube is configured to permit liquid to drain from reservoir volume.

31. The method of claim 30, wherein the first core assembly is a male core assembly and the second core assembly is a female core assembly, wherein the male core assembly includes the passageway that is configured to correspond to a shape of a male urethra, and wherein the female core assembly includes the passageway that is configured to correspond to a shape of a female urethra.

32. The method of claim 30, wherein the first core assembly is a first male core assembly and the second core assembly is a second male core assembly, wherein the first male core assembly includes the passageway that is configured to correspond to a shape of a male urethra with a first abnormal condition, and wherein the second male core assembly includes the passageway that is configured to correspond to a shape of a male urethra with a second abnormal condition.

33. The method of claim 30, further comprising,
removing the practice core assembly from the cavity of the core housing;
inserting the other of the first core assembly and the second core assembly into the cavity;
selecting between the male genital assembly and the female genital assembly based on a shape of the other of the first core assembly and the second core assembly into the cavity; and
connecting a selected one of the male genital assembly and the female genital assembly to the other of the first core assembly and the second core assembly into the cavity.

34. The method of claim 30, wherein the reservoir assembly further includes a support plate coupled to the reservoir volume, the method further comprising inserting the support plate into a groove on the core housing and inserting a nozzle of the reservoir volume into an opening on the practice core assembly to fluidly connect the passageway to the reservoir volume.
